(19) United States
(12) Patent Application Publication
(10) Pub. No.: US 2011/0267282 A1
(43) Pub. Date: Nov. 3, 2011

(54) WIRELESS HUMAN MACHINE INTERFACE APPARATUS, CLOUD COMPUTING SYSTEM AND PORTABLE COMPUTER

(75) Inventors: Yue-Li Chao, Taoyuan County (TW); Chun-Lun Pan, Tainan City (TW)

(73) Assignee: CHUNGHWA PICTURE TUBES, LTD., Taoyuan (TW)

(21) Appl. No.: 12/826,704

(22) Filed: Jun. 30, 2010

(30) Foreign Application Priority Data
Apr. 30, 2010 (TW) 99208077

(51) Int. Cl. G06F 3/041

(52) U.S. Cl. 345/173

(57) ABSTRACT

A wireless human machine interface apparatus, a cloud computing system and a portable computer are provided. The wireless human machine interface apparatus is adapted to a host installing an operating system. The host is coupled to a first wireless transceiver. The wireless human machine interface apparatus includes a second wireless transceiver, a touch sensor, and a display panel. The second wireless transceiver is configured to communicate with the first wireless transceiver. The touch sensor serves as an input device of the operating system through the second wireless transceiver and the first wireless transceiver. The display panel serves as an output device of the operating system through the second wireless transceiver and the first wireless transceiver.

### CROSS-REFERENCE TO RELATED APPLICATION

This application claims the priority benefit of Taiwan application serial no. 99208077, filed on Apr. 30, 2010. The entirety of the above-mentioned patent application is hereby incorporated by reference herein and made a part of specification.

### BACKGROUND

1. Field of the Invention

The present invention relates to a cloud computing system. More particularly, the present invention relates to a wireless human machine interface apparatus serving as an input/output device of a host.

2. Description of Related Art

Since touch screens have an advantage of high humanization, more and more portable electronic devices (for example, a tablet computer, a touch control smart phone and a personal digital assistant (PDA), etc.) adopt the touch screens as input/output devices thereof.

It should be noticed that a portable electronic device, such as the tablet computer, the touch control smart phone or the PDA, has to be operated with installing an operating system (OS). Therefore, a storage module, which is used for installing the OS, and a processor are required to be disposed within the portable electronic device, meanwhile the size, weight and power consumption of the portable electronic device are also substantially increased.

### SUMMARY

The present invention is directed to a wireless human machine interface apparatus, which facilitates improving an operation convenience of a host.

The present invention is directed to a cloud computing system, in which computation parts are handed over to a host, and in collaboration with a wireless human machine interface apparatus serving as an output/input device of the host, the whole system has advantages of high mobility and high computing performance.

The present invention is directed to a portable computer, which can serve as a personal computer and can further serve as a small cloud computing system according to a requirement of a user.

The present invention provides a wireless human machine interface apparatus, which is adapted to a host installing an operating system. The host is coupled to a first wireless transceiver. The wireless human machine interface apparatus includes a second wireless transceiver, a touch sensor, and a display panel. The second wireless transceiver is configured to communicate with the first wireless transceiver. The touch sensor serves as an input device of the operating system through the second wireless transceiver and the first wireless transceiver. The display panel serves as an output device of the operating system through the second wireless transceiver and the first wireless transceiver.

According to another aspect, the present invention provides a cloud computing system, which includes a host and a first wireless human machine interface apparatus. The host includes a chip set and a storage module. The chip set is coupled to a first wireless transceiver. The storage module is installed with an operating system, and is coupled to the chip set. The first wireless human machine interface apparatus includes a second wireless transceiver, a first touch sensor, and a first display panel. The second wireless transceiver is configured to communicate with the first wireless transceiver. The first touch sensor serves as a first input device of the operating system through the second wireless transceiver and the first wireless transceiver. The first display panel serves as a first output device of the operating system through the second wireless transceiver and the first wireless transceiver.

In an exemplary embodiment of the present invention, the cloud computing system further includes a second wireless human machine interface apparatus. The second wireless human machine interface apparatus includes a third wireless transceiver, a second touch sensor and a second display panel. The third wireless transceiver is configured to communicate with the first wireless transceiver. The second touch sensor serves as a second input device of the operating system through the third wireless transceiver and the first wireless transceiver. The second display panel serves as a second output device of the operating system through the third wireless transceiver and the first wireless transceiver.

In an exemplary embodiment of the present invention, the first wireless human machine interface apparatus is not installed with another operating system.

In an exemplary embodiment of the present invention, the first wireless human interface further includes a universal serial bus (USB) interface. The USB interface serves as a USB interface of the operating system through the second wireless transceiver and the first wireless transceiver.

In an exemplary embodiment of the present invention, the first wireless human machine interface apparatus further includes a second power module. The second power module is coupled to the second wireless transceiver, the first touch sensor and the first display panel.

In an exemplary embodiment of the present invention, the second power module includes a battery, a chargeable battery or a power converter.

According to another aspect, the present invention provides a portable computer, which includes a host and a wireless human machine interface apparatus. The host includes a chip set, a storage module, a first wireless transceiver and a first detachable connection device. The storage module is installed with an operating system and is coupled to the chip set. The first wireless transceiver is coupled to the chip set. The first detachable connection device is coupled to the chip set. The wireless human machine interface apparatus includes a second wireless transceiver, a second detachable connection device, a touch sensor and a display panel. The second wireless transceiver is configured to communicate with the first wireless transceiver. The second detachable connection device is detachably connected to the first detachable connection device. The touch sensor serves as an input device of the operating system through the second wireless transceiver and the first wireless transceiver or through the first detachable connection device and the second detachable connection device. The display panel serves as an output device of the operating system through the second wireless transceiver and the first wireless transceiver or through the first detachable connection device and the second detachable connection device.

According to the above descriptions, in the present invention, the touch sensor and the display panel of the wireless human machine interface apparatus can serve as the output input devices of the host through the wireless transceivers. By handing over computation parts to the host, a high computing performance is maintained, and a power consumption of the wireless human machine interface apparatus is reduced, so as to substantially improve portability of the wireless human machine interface apparatus.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a cloud computing system and a wireless human machine interface apparatus according to a first exemplary embodiment of the invention.

FIG. 2 is a schematic diagram illustrating a cloud computing system and a wireless human machine interface apparatus according to a second exemplary embodiment of the invention.

FIG. 3 is a schematic diagram illustrating a cloud computing system and a host according to a third exemplary embodiment of the invention.

FIG. 4 is a schematic diagram illustrating a portable computer according to a fourth exemplary embodiment of the invention.

FIG. 5 is a schematic diagram illustrating a portable computer according to a fifth exemplary embodiment of the invention.

### DETAILED DESCRIPTION OF DISCLOSED EMBODIMENTS

In the conventional technique, an operating system has to be installed in a portable electronic device adopting a touch screen, which may cause that the size, weight and power consumption of the portable electronic device are substantially increased.

Comparatively, exemplary embodiments of the invention provides a concept of a cloud computing system, and the cloud computing system includes a host and a wireless human machine interface apparatus having a touch screen function. An operating system is installed in the host, and the host provides a computation service. In collaboration with a wireless transmission technique, for example, a wireless fidelity (WiFi) technique or an ultra wideband network, a wireless transmission channel between the wireless human machine interface apparatus and the host is established. The wireless human machine interface apparatus can directly serve as an output/input device of the host through the wireless transmission channel. In this case, the wireless human machine interface apparatus is unnecessary to be installed with any operating system. A user can directly operate the operating system of the host through the wireless human machine interface apparatus, so as to mitigate the aforementioned conventional problems and make a full use of the high computing performance of the host. Reference will now be made in detail to the present preferred embodiments of the invention, examples of which are illustrated in the accompanying drawings. Wherever possible, the same reference numbers are used in the drawings and the description to refer to the same or like parts.

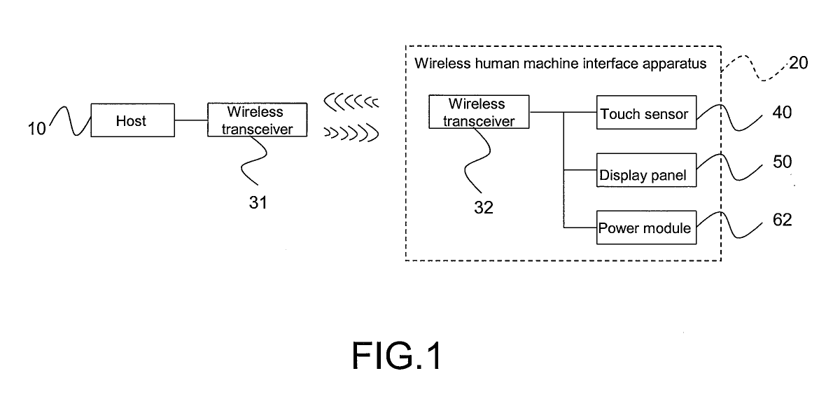

FIG. 1 is a schematic diagram illustrating a cloud computing system and a wireless human machine interface apparatus according to a first exemplary embodiment of the invention. Referring to FIG. 1, the cloud computing system includes a host 10 and a wireless human machine interface apparatus 20. The host 10 is coupled to a wireless transceiver 31. The wireless human machine interface apparatus 20 includes a wireless transceiver 32, a touch sensor 40 and a display panel 50. Moreover, the wireless human machine interface apparatus 20 may further include a power module 62. The touch sensor 40 and the display panel 50 may be regarded as a touch screen.

The host 10 is, for example, a server or a computer host, etc., and it is not limited thereto. Any electronic device capable of installing an operating system and having a high computing performance can be used as the host of the cloud computing system. In the present exemplary embodiment, the host 10 is installed with an operating system, and has a multiplex computing capability and a high computing performance. The wireless transceiver 32 is used to communicate with the wireless transceiver 31. In other words, the host 10 establishes a wireless transmission channel with the wireless human machine interface apparatus 20 according to a wireless transmission technique. In this way, the touch sensor 40 serves as an input device of the operating system installed in the host 10 through the wireless transceivers 32 and 31, and the display panel 50 serves as an output device of the operating system installed in the host 10 through the wireless transceivers 32 and 31.

According to the above descriptions, the touch sensor 40 is, for example, a resistive or a capacitive touch sensor, an optical touch sensor or an acoustic touch sensor. A user may perform physical touch or non-physical touch to the touch sensor 40 (touch a sensing area of the touch sensor 40) through a finger or a stylus. In other words, the touch sensor 40 generates a corresponding control signal according to a touch event executed by the user. The wireless transceiver 32 converts the control signal into a wireless signal and transmits it to the wireless transceiver 31 in a wireless transmission approach. The wireless transceiver 31 may recover the received wireless signal to the control signal. The host 10 then performs corresponding controlling according to the control signal recovered by the wireless transceiver 31. In this way, the user may control the operating system of the host 10 through the touch sensor 40 of the wireless human machine interface apparatus 20.

On the other hand, the host 10 may output a video signal to the wireless transceiver 31. The wireless transceiver 31 converts the received video signal into a wireless signal, and transmits it to the wireless transceiver 32 in a wireless transmission approach. The wireless transceiver 32 recovers the wireless signal provided by the wireless transceiver 31 into the video signal, and provides it to the display panel 50. The display panel 50 displays a corresponding video image according to the received video signal. In this way, the user may monitor an operation of the operating system of the host 10 through the display panel 50 of the wireless human machine interface apparatus 20.

To achieve a high mobility of the wireless human machine interface apparatus 20, in the present exemplary embodiment, the power module 62 is implemented by a battery which provides power for various devices and modules in the wireless human machine interface apparatus 20. Certainly, in another exemplary embodiments, the power module 62 may also be implemented by a chargeable battery, for example, a lithium battery, or other types of battery. An external power converter can be used to charge the chargeable battery. Those skilled in the art can also integrate the power converter into the power module 62 according to an actual design requirement.

It should be noticed that in the present exemplary embodiment, the wireless human machine interface apparatus 20 serves as an output/input interface of the host 10 without installing an extra operating system. In particular, because the wireless human machine interface apparatus 20 is not needed to install the extra operating system, a large amount of hardware can be saved, for example, a storage module used for installing the operating system or a chip set used for computing processing, etc. is saved. Therefore, the size, weight and power consumption of the wireless human machine interface apparatus 20 can be substantially reduced. Reduction of the size and weight of the wireless human machine interface apparatus 20 can effectively improve a convenience of portability thereof. Reduction of the power consumption can effectively improve a battery durability of the wireless human machine interface apparatus 20. Moreover, computation parts can be handed over to the host 10, so as to make a full use of the high computing performance of the host 10. Such structure can give a full play of the cloud computing system, so as to achieve a high computing performance and high mobility.

Although a possible pattern of the cloud computing system and the wireless human machine interface apparatus has been described in the above exemplary embodiment, it should be understood by those skilled in the art that designs of the cloud computing system and the wireless human machine interface apparatus varies with manufacturers, thus, the present invention should not be limited to the above exemplary embodiment. In other words, the spirit of the present invention is met as long as the wireless human machine interface apparatus having a touch sensing and a display functions is used. To provide a further understanding of the invention for those skilled in the art, exemplary embodiments are provided below for further descriptions.

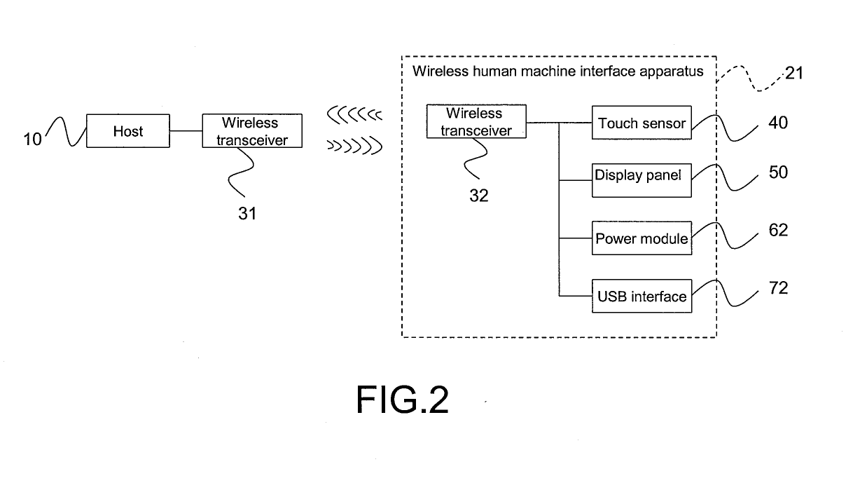

The structure of the wireless human machine interface apparatus 20 of FIG. 1 is only an example, and the present invention is not limited thereto. Those skilled in art can modify the structure of the wireless human machine interface apparatus according to an actual design requirement. For example, FIG. 2 is a schematic diagram illustrating a cloud computing system and a wireless human machine interface apparatus according to a second exemplary embodiment of the invention. Referring to FIG. 1 and FIG. 2, the wireless human machine interface apparatus 21 of FIG. 2 is similar to the wireless human machine interface apparatus 20 of FIG. 1, and a difference there between is that the wireless human machine interface apparatus 21 of FIG. 2 further includes a universal serial bus (USB) interface 72. The USB interface 72 may support various types of USB devices, for example, a USB mouse, a USB keyboard, a flash drive, etc. Moreover, the USB interface 72 serves as a USB interface of the host 10 through the wireless transceivers 32 and 31. The power required by the USB interface 72 is provided by the power module 62.

According to the above description, after a wireless transmission channel is established between the wireless transceivers 31 and 32, when the USB interface 72 is connected with a USB device, a USB signal generated by the USB device can be transmitted to the wireless transceiver 32 through the USB interface 72. The wireless transceiver 32 converts the USB signal into a wireless signal and transmits it to the wireless transceiver 31 in a wireless transmission approach. The wireless transceiver 31 recovers the wireless signal to the USB signal, and provides it to the host 10, and the host 10 reacts according to the received USB signal.

Similarly, a USB signal generated by the host 10 can also be transmitted to the wireless transceiver 31, and the wireless transceiver 31 converts the USB signal into a wireless signal and transmits it to the wireless transceiver 32 in a wireless transmission approach. The wireless transceiver 32 recovers the received wireless signal to the USB signal, and transmits it to the USB device through the USB interface 72.

It should be noticed that in the other exemplary embodiments, the wireless transceiver 32, the touch sensor 40 or the display panel 50 may also be integrated to the wireless human machine interface apparatus 21 through a USB interface expansion approach without being built in the wireless human machine interface apparatus 21.

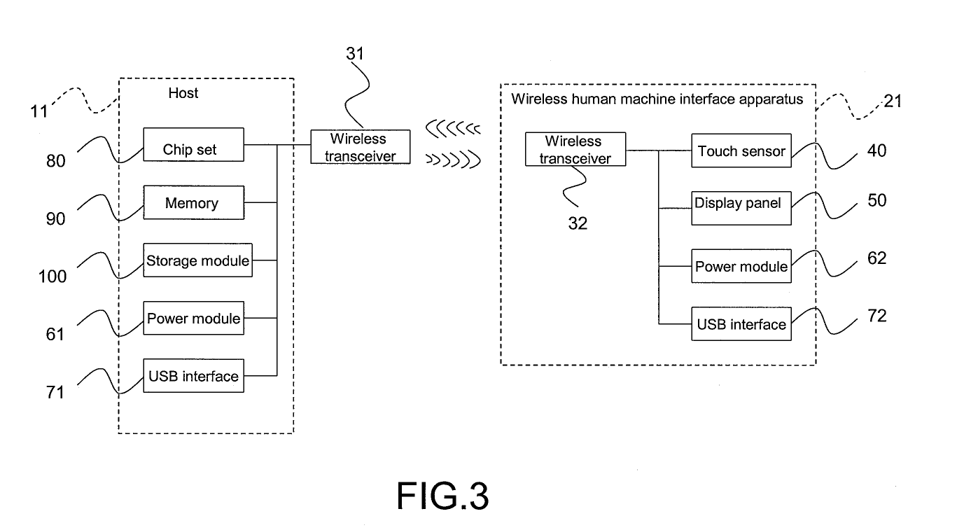

In FIG. 1, the host 10 is, for example, a server or a computer host. Those skilled in the art should understand that a structure of the server or the computer host can be adjusted according to an actual design requirement. A structure of the host is provided below for those skilled in the art. FIG. 3 is a schematic diagram illustrating a cloud computing system and a host according to a third exemplary embodiment of the invention. Referring to FIG. 3, in the present exemplary embodiment, the host 11 includes a power module 61, a USB interface 71, a chip set 80, a memory 90 and a storage module 100. The chip set 80 may include a central processor, a north bridge chip, a south bridge chip, a graphic processing unit, etc. The memory 90 is, for example, a dynamic random access memory. The storage module 100 is, for example, a hard drive or a solid state drive. The power module 61 is, for example, a power supply. The USB interface 71 may support various types of the USB devices.

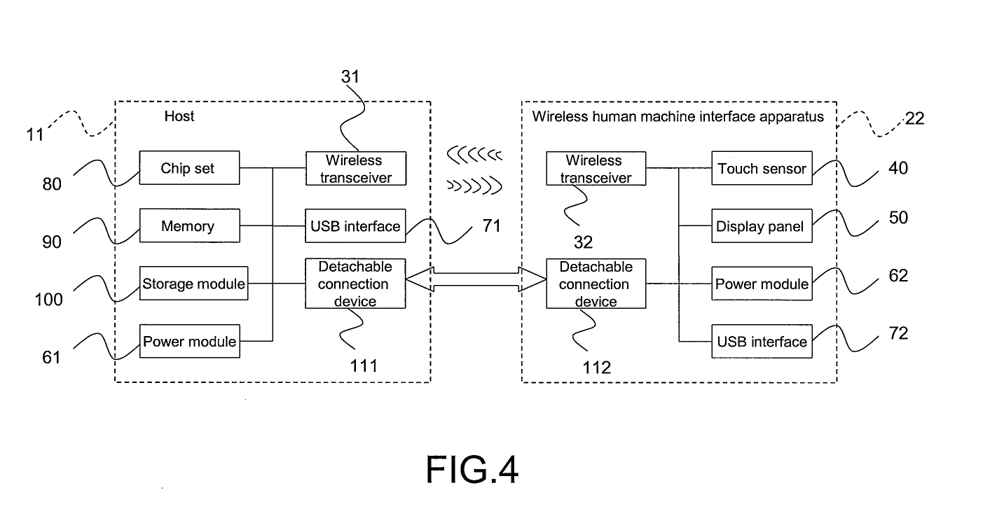

It should be noticed that the spirit of the invention can also be applied to a portable computer. For example, FIG. 4 is a schematic diagram illustrating a portable computer according to a fourth exemplary embodiment of the invention. The portable computer includes a host 11 and a wireless human machine interface apparatus 22. The host 11 may include the wireless transceiver 31, the power module 61, the USB interface 71, the chip set 80, the memory 90, the storage module 100 and a detachable connection device 111. The power module 61 is, for example, a chargeable battery, which can be charged through an external power converter.

The wireless human machine interface apparatus 22 includes the wireless transceiver 32, the touch sensor 40, the display panel 50, the power module 62, the USB interface 72 and a detachable connection device 112.

It should be noticed that the detachable connection device 112 may be connected to the detachable connection device 111, and may also be detached from the detachable connection device 111. Namely, the host 11 and the wireless human machine interface apparatus 22 may be combined through the detachable connection devices 111 and 112 to establish a transmission channel. The host 11 and the wireless human machine interface apparatus 22 may be detached or combined according to a user's requirement.

When the host 11 and the wireless human machine interface apparatus 22 are mutually detached, the portable computer can be regarded as a small cloud computing system. A wireless transmission channel can be established between the host 11 and the wireless human machine interface apparatus 22 through the wireless transceivers 32 and 31, so that various devices in the wireless human machine interface apparatus 22 may communicate with the host 11 through the wireless transmission channel. Such method can improve a mobility of the portable computer without influencing a computing capability of the portable computer.

When the host 11 and the wireless human machine interface apparatus 22 are combined through the detachable connection devices 111 and 112, the portable computer may be regarded as a personal computer which is easy to be carried around. At this time, the host 11 may communicate with the wireless human machine interface apparatus 22 through the detachable connection devices 111 and 112 or the wireless transceivers 31 and 32.

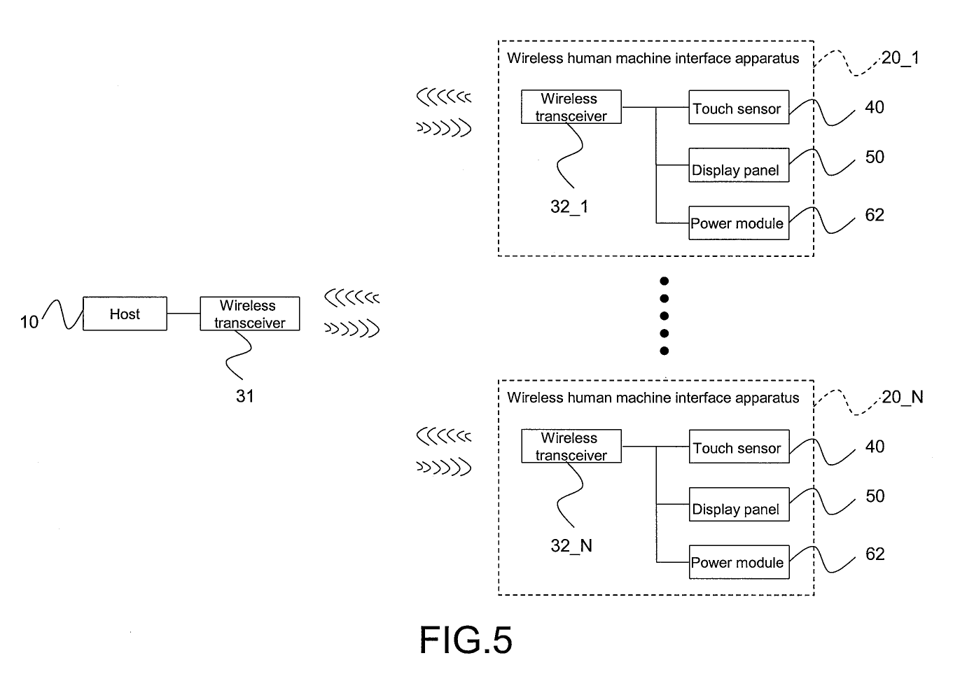

Moreover, the spirit of the invention can also be applied to a situation that one host supports a plurality of wireless human machine interface apparatuses. For example, FIG. 5 is a schematic diagram illustrating a portable computer according to a fifth exemplary embodiment of the invention. Referring to FIG. 5, since the host 10 has a multiplex computing capability and a high computing performance, it is capable of supporting multiple wireless human machine interface apparatuses. In the present exemplary embodiment, N wireless human machine interface apparatuses (20_1˜20_N) respectively having discernible wireless transceivers (32_1˜32_N) are taken as an example, wherein N is a positive integer.

The host 10 may set a corresponding account for each of the wireless human machine interface apparatuses 20_1˜20_N, and then users may send control commands to the host 10 through the wireless human machine interface apparatuses 20_1˜20_N. In this way, the host 10 simultaneously serves multiple users.

Moreover, the wireless human machine interface apparatus can also be integrated to various electronic devices, for example, the wireless human machine interface apparatus may be integrated to a smart refrigerator to serve as a human machine interface apparatus of the smart refrigerator. In this way, a problem of battery durability of the wireless human machine interface apparatus is unnecessary to be considered. The user may operate the host through the wireless human machine interface apparatus, and may also operate the smart refrigerator through the wireless human machine interface apparatus. Certainly, the above various electronic devices further include smart air conditioners, smart washing machines, etc.

In summary, according to the wireless communication technique of the invention, the wireless human machine interface apparatus having a touch screen is taken as the output/input interface of the host, so as to achieve a high mobility and high computing performance of the cloud computing system. Moreover, the exemplary embodiments of the invention further have following advantages:

1. The computation parts can be handed over to the host, and by strengthening computing chips and a hardware structure of the host, a powerful computing performance can be implemented.

2. The wireless human machine interface apparatus is unnecessary to be installed with an operating system, so that a hardware cost is saved and a hardware structure is simplified. Accordingly, the size, weight and power consumption of the wireless human machine interface apparatus can be reduced, so as to substantially improve a convenience of portability and battery durability thereof.

3. The host can be set to serve multiple wireless human machine interface apparatuses, so as to achieve an advantage of one machine multipurpose.

4. The portable computer may apply the wireless human machine interface apparatus having a touch screen function and a detachable function. When the host and the wireless human machine interface apparatus are detached, the portable computer can be regarded as a small cloud computing system, and when the host and the wireless human machine interface apparatus are combined, the portable computer still maintains various advantages of the portable computer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wireless human machine interface apparatus, for a host installing an operating system, wherein the host is coupled to a first wireless transceiver, the wireless human machine interface apparatus comprising:
a second wireless transceiver, for communicating with the first wireless transceiver;
a touch sensor, serving as an input device of the operating system through the second wireless transceiver and the first wireless transceiver; and
a display panel, serving as an output device of the operating system through the second wireless transceiver and the first wireless transceiver.

2. A cloud computing system, comprising:
a host, comprising:
a chip set, coupled to a first wireless transceiver; and
a storage module, installing an operating system, and coupled to the chip set; and
a first wireless human machine interface apparatus, comprising:
a second wireless transceiver, for communicating with the first wireless transceiver;
a first touch sensor, serving as a first input device of the operating system through the second wireless transceiver and the first wireless transceiver; and
a first display panel, serving as a first output device of the operating system through the second wireless transceiver and the first wireless transceiver.

3. The cloud computing system as claimed in claim 2, further comprising:
a second wireless human machine interface apparatus, comprising:
a third wireless transceiver, for communicating with the first wireless transceiver;
a second touch sensor, serving as a second input device of the operating system through the third wireless transceiver and the first wireless transceiver; and
a second display panel, serving as a second output device of the operating system through the third wireless transceiver and the first wireless transceiver.

4. The cloud computing system as claimed in claim 2, wherein the first wireless human machine interface apparatus is not installed with another operating system.

5. The cloud computing system as claimed in claim 2, wherein the first wireless human interface further comprises:
a universal serial bus (USB) interface, serving as a USB interface of the operating system through the second wireless transceiver and the first wireless transceiver.

6. The cloud computing system as claimed in claim 2, wherein the first wireless human machine interface apparatus further comprises:
a second power module, coupled to the second wireless transceiver, the first touch sensor and the first display panel.

7. The cloud computing system as claimed in claim 6, wherein the second power module comprises a battery, a chargeable battery or a power converter.

8. A portable computer, comprising:
a host, comprising:
a chip set;
a storage module, installing an operating system, and coupled to the chip set;
a first wireless transceiver, coupled to the chip set; and
a first detachable connection device, coupled to the chip set; and
a wireless human machine interface apparatus, comprising:
a second wireless transceiver, for communicating with the first wireless transceiver;
a second detachable connection device, detachably connected to the first detachable connection device;
a touch sensor, serving as an input device of the operating system through the second wireless transceiver and the first wireless transceiver or through the first detachable connection device and the second detachable connection device; and
a display panel, serving as an output device of the operating system through the second wireless transceiver and the first wireless transceiver or through the first detachable connection device and the second detachable connection device.
